(19) United States
(12) Patent Application Publication
(10) Pub. No.: US 2015/0371303 A1
(43) Pub. Date: Dec. 24, 2015

(54) LOCALIZED MERCHANT SYSTEM WITH ALERTING TO INCOMING CUSTOMERS' VOLUNTARY DISCLOSURE

(71) Applicant: Services Personalized Inc., Southlake, TX (US)

(72) Inventors: Gurvendra S. Suri, Southlake, TX (US); Samuel J. Sliman, Tupelo, MS (US); Pallab Chatterjee, Plano, TX (US)

(21) Appl. No.: 14/742,646

(22) Filed: Jun. 17, 2015

Related U.S. Application Data
(60) Provisional application No. 62/013,657, filed on Jun. 18, 2014.
(60) Provisional application No. 62/015,685, filed on Jun. 23, 2014.

(51) Int. Cl. G06Q 30/06; H04W 4/02

(52) U.S. Cl. CPC G06Q 30/0613; H04W 4/023

(57) ABSTRACT

The present application provides new omni-channel marketing capabilities for merchants having physical store locations. When a customer walks up to the physical location, the salespeople are alerted to the customer's presence, and are given information on the customer's preferences—IF the customer has chosen to make that information available to this merchant, or to merchants of this kind. The nearest or most suitable salespeople are cued with the customer's picture and first name, and given information such as sizes, shopping purpose, and general preferences. This permits personalized service interactions to be launched very quickly, and can rapidly build high customer loyalty. The system architecture allows the customer to retain control over her own personal information, and thereby makes it safer for customers to share that information on a limited basis. Tying information to physical locations and authorized merchant users avoids many paths to leakage of personal information.

### CROSS-REFERENCE

Priority is claimed from 62/013,657 filed Jun. 18, 2014, which is hereby incorporated by reference.

Priority is also claimed from 62/015,685 filed Jun. 23, 2014, which is hereby incorporated by reference.

### BACKGROUND

The present application relates to the electronics infrastructure in a retail store, or in similarly service-dependent physical locations such as restaurants, banks, hotels, airports, casinos, hospitals, etc.

Note that the points discussed below may reflect the hindsight gained from the disclosed inventions, and are not necessarily admitted to be prior art.

The full impact of e-commerce is still hitting retailers, and the whole business model of retail sales is changing. Amazon, for example, has given consumers a way to buy almost anything they can identify a need for, without going to a physical store.

One way to compensate for this challenge is “hyperpersonalization.” The more a retailer knows about a consumer's preferences, the better that retailer can satisfy that consumer's wishes and goals. This makes that retailer more likely to stand out in the consumer's memory, and more likely to develop an ongoing relationship.

Many brick-and-mortar retailers aim at “omni-channel” selling interactions. The concept is that a consumer can maintain the hyperpersonalized interaction preferences across all channels of commerce. This includes inter alia internet buying, mobile access, and in-store face-to-face interaction.

On another front, the restaurant industry is not threatened by remote fulfillment, but restaurateurs still face continuous challenges. The barriers to entry are low, and the return to investment on a successful restaurant launch can be high; this means that the restaurant business has a continual ferment of new entrants and new approaches. For example, the new customer interaction model introduced by Starbucks proved extremely successful, and many coffee shops found themselves quickly obsoleted. Some restaurants have started loyalty programs, which can work well for fervent followers, but it is not so easy to extend loyalty programs to friendly-but-occasional customers.

The present application teaches, among other innovations, new infrastructure for physical stores and the like. The new kind of store has hardware which detects and identifies customers who are candidates for hyperpersonalized service, and launches customized service based on identified points of fit. This is achieved by a process which includes voluntary disclosure, under the customer's control, of the customer's profile and preferences.

The above innovations are implemented, in various disclosed embodiments, by an in-store system which includes: presence detection hardware (e.g. geofencing or beacon or WiFi or packet sniffing or face recognition) which detects the presence of a customer who has chosen to cooperate with the personalization architecture; an interface which can receive secure personalization disclosure from a physically present disclosing customer, and can send tailored offers, recommendations, and experiences to that customer; and salesperson-alerting displays which cue the appropriate salespeople (if any) with key points for a physically present disclosing customer. (This summary does not delimit the claimed inventions, but simply provides some help in distinguishing the most clear novel structure and function from extensions and additions.)

Many modifications, variations, extensions and additions are indicated, and the scope of the claimed inventions is defined only by the claims themselves.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 shows one sample embodiment of the present inventions.

FIG. 2 shows another sample embodiment of the present inventions.

FIG. 3 shows another sample embodiment of some functions provided by the present inventions.

FIG. 4 shows another sample embodiment of the present inventions from a hardware perspective.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

Numerous terms used herein are ones with special meanings understood by one of ordinary skill in the art and should not necessarily be given their plain English meaning, including but not limited to “geofencing” and “hyperpersonalization.”

“Geofencing” as used herein can include any system used to indicate when a user (and their mobile device) has crossed into or out of a pre-defined geographic boundary, and preferably also to indicate where the user is within that boundary. Geofencing can use GPS location, wireless network detection, location triangulation from cell towers and/or wireless networks, or other systems or technologies that provide similar functionality. Whichever technique is used, some hardware and interfacing is required in order to implement the geofencing operation.

“SP” is used in this application to refer to elements which cooperate with the disclosed architecture. An “SP shopper,” for example, is a shopper carrying a mobile app which implements the functions described.

### The Personalization Gap

Analytics can be used to derive information about individuals from observation and inadvertently revealed data. However, it is worth considering how much more information could be gotten from the real individual, and how useful that degree of information would be for successful selling to customers. Consider a hypothetical Shopper “Meredith,” and what information would be helpful in selling to her:
Basic Facts: Age, Gender, Birthday, Income, Marital Status, Family, Education, Allergies
History: Transactions
Interests: Activities, Hobbies, Sports Teams, Music, Movies

. . . Favorites: Sizes, Styles, Brands, Tastes, Payment Mode, Privacy, Standard Order . . . .

Marketers want access to consumers like Meredith, but they know little or nothing about her. They are guessing at what she likes/dislikes. They don't know when she walks in their store, and they can't be sure it's her when she visits their website, uses their mobile app, or comments on social media.

Meredith wants personalized service, but on her terms, rather than on the merchants' or marketers' terms. However, the merchants' understanding of her is superficial; offers she receives are irrelevant or redundant; and product selection is not tailored to her tastes. She will volunteer information about herself to improve the experience, but she wants control over how that information is shared with merchants.

The personalization gap between marketers and consumers is created by, among other factors, incomplete and inaccurate consumer data; faulty personalization algorithms; limited view of consumer's purchase history; and predictive models built on questionable assumptions. The present innovations provide ways to bridge this gap.

An SP user can define preferences through an SP user interface, and preferably chooses who can access these preferences when. In some sample embodiments, the SP user can choose to grant access both to merchants and also to other SP users. Selected SP merchants are then able to access her preferences under certain conditions to facilitate merchant-user interactions.

SP platforms according to the present inventions facilitate the connection between merchant and consumer, giving users control over how and when preferences are shared. It also gives merchants an accurate picture of consumer preferences—and the best tools to leverage them.

The present application teaches inter alia that cloud-based technology is combined with mobile applications designed to maximize customer loyalty by providing a highly personalized, omni-channel experience for customers interacting with merchants in or near a physical retail location, on a merchant's website, or using a merchant's mobile application. Presently-preferred sample embodiments are initially targeted at consumers visiting commercial outlets like restaurants, retail stores, hotels, and airports. However, the present innovations are equally applicable to other merchant categories like automobile dealerships, spas, hospitals and clinics, where knowledge of an individual's preferences and/or history can improve service levels and customer satisfaction.

The present innovations enable a personalized customer experience by accumulating extensive data on each customer's unique preferences and providing participating merchants with a set of mobile tools and apps that leverage customer preferences to customize near-location, in-location, on-website, and in-mobile-app service experiences.

The present innovations enable consumers to store, update and communicate their preferences to merchants in real-time so they get the level of service they expect, when they expect it. Importantly, consumers control if and when the preferences are communicated to merchants, giving them peace of mind that their data is only transmitted with their permission and to whom they choose. Sharing also includes other consumers, through social sharing features, and helps consumers shop for others by providing access to their preferences.

It is a proven fact that customers prefer to frequent outlets where they have an established relationship and where they are treated in a customized manner, according to their personal tastes and predilections. However, it is a major challenge for merchants to understand customer preferences, at a level of detail that allows a truly personalized experience, and to know who is near or in their properties (physical, Internet or mobile app) at any point in time, so that they can offer or provide something unique to the customer.

Additionally, even if merchants have addressed these challenges, they are not conventionally equipped with tools to enable and automate these highly personalized interactions and provide analytical capabilities to measure their effectiveness.

The present application teaches inter alia approaches to these problems. At a basic level, the present inventions identify individuals who have opted-in to SP programs (“SP Users”) when they visit merchant's physical locations, websites or use their mobile apps.

SP User recognition processes work only when a SP User accesses SP-Enabled merchants. Preferred sample embodiments preferably include the following components:

1. SP User App: An SP User App is most preferably the primary way in which a user interacts with the present innovations in order to set up and manage their preferences. As a secondary option, SP Users can also set up and manage their preferences online. Any of the SP User App components can also be included in a merchant's in-store, in-website or in-app experience for seamless integration with the present inventions. An SP User App interacts with an SP Hub, and most preferably includes e.g. the following components:
1.a. User Account Setup: Basic screens to setup a user account within an SP implementation. SP Users can provide basic demographic data (possibly populated through a social media account such as Facebook, Pinterest, or other online account) that can include, inter alia:
   1.a.i. Biographic data: Photo, name, gender, age, location, income bracket, homeowner status, marital status, number of kids, occupation, cell number, primary email address, ship-to and bill-to addresses, preferred shipping speed, preferred payment method, credit card information, receipt/no-receipt, and email vs. physical delivery preferences.
   1.a.ii. Body type/model: In some sample embodiments, an SP User can store a digital version of their body model, captured using a specialized body model device.
   1.a.iii. Wish List: A global wish list preferably allows an SP User to store items they want, so that other SP Users can purchase the items for them.
   1.a.iv. Standard Order: An SP User can store an order they frequently use.
   1.a.v. Advance Order: An SP User can preferably transmit an order to an SP-enabled location prior to their arrival, so it can be ready by the time they arrive.
1.b. Preference Sharing, Trending/Alerts & Crowdsourcing: Similarly to a social network, an SP User can preferably invite other SP Users to share their preferences, their experiences with SP-enabled merchants, their Wish Lists, and other content. In some implementations, SP Users can compare their preferences with other SP Users with “Trending/Alerts” reports that highlight brands, products and services that are increasingly preferred by (or have fallen out of favor with) other SP Users based on criteria the SP User can set. For example, an SP User can e.g. view statistics for “SP Users That Share My Demographic”, “SP Users In General”, “SP Users in My Zip Code”, etc. In some sample embodiments, during an in-store transaction, SP Users can request real-time, crowdsourced feedback on a particular product/service from other SP Users. This could include, for example, an uploaded picture of a dress being tried on in a dressing room, where the SP User wants feedback from other SP Users on style or appropriate accessories. Additionally, an SP User might query the SP Platform for “SP Users Like Me” and see what similar individuals prefer.
1.c. Preference Builder: Preference builder functionality according to the present inventions collects users' personal preferences through a combination of (a) explicit, user-provided demographic and account details, (b) analytics on transaction history, (c) non-intrusive surveys designed to extract relevant details, (d) spoken or typed ad-hoc notes recorded by service staff who interact with SP Users, (e) SP User behavior when presented with promotions, and/or (f) through social media commentary. A Preference Builder most preferably features multiple preference categories that correspond to different types of stores, e.g.:
   1.c.i. Apparel: Apparel preference data can include, for example, typical shoe size/width, shirt, shoe and pant size, style preferences, favorite stores, favorite suit/dress, and favorite brands, etc.
   1.c.ii. Dining Dining preferences can include e.g. known allergies, vegetarian/vegan preference, Kosher, alcohol vs. non-alcoholic, favorite restaurants, favorite dishes, a Do Not Like list, etc.
   1.c.iii. Home: These preferences can include e.g. renter vs. homeowner status, modern vs. traditional taste, favorite home furnishing stores, number of bedrooms, etc.
   1.c.iv. Digital: These preferences can include e.g. Apple vs. Android vs. MSFT, an SP User's cellphone carrier, Broadband provider, etc.
   1.c.v. Entertainment: These preferences can include e.g. magazines subscribed to (online and offline), favorite newspaper/news programs, favorite TV shows/networks, favorite bands, last concert attended, last movie watched, favorite book, last book read, whether the SP User subscribes to a video-on-demand service such as Netflix, favorite male/female celebrities, etc.
   1.c.vi. Grocery: These preferences can include e.g. vegetarian/vegan, favorite brands, alcohol vs. non-alcohol, Kosher, food allergies, etc.
   1.c.vii. Travel: These preferences can include e.g. hotel preferences, frequent flier programs and details, number of cars, makes and models, dream vehicle, bus or subway rider, etc.
   1.c.viii. Medical: These preferences can include e.g. known allergies, prescriptions, any medical history that can be shared, etc.
   1.c.ix. Activities & Interests: This section can include, for example, answers to questions such as What are your hobbies? Where would you live if you could live anywhere? Favorite vacation destination? Do you work out of your home/apartment? Favorite websites/e-commerce sites?
   1.c.x. Preferences can also be augmented by ad-hoc “Do You Prefer” questions. For example, an SP User can be presented with two pictures (e.g. two different outfits, cars, locations) and asked which of the two they prefer. Some sample embodiments can also provide feedback on what other SP Users prefer.
1.d. Recognition Settings: SP Users can most preferably opt-out of recognition (and therefore communication of preferences) at specific SP-enabled retail locations, and can filter this e.g. by brand, distance from home, city, zip code, or other relevant criteria.
1.e. In-Transaction Features:
   1.e.i. Shopping Intent: When an SP User enters a merchant's physical location, website or app, some sample implementations of SP User Apps can request details on the SP User's shopping intent for that visit. This is accomplished by a dialogue that requests information such as:
      1) Who are you shopping for today, yourself or others?
      2) If others, are they male or female? Are they in your SP Network?
      3) Is it a special occasion (birthday, anniversary, graduation, etc.)?
      4) What type of items are you looking for (apparel, cosmetics, furnishings, etc.)?
      5) What price point do you prefer?
   1.e.ii. “Do Not Disturb” or “I Need Help”: SP Users can most preferably select on-the-fly preferences like “Do Not Disturb” if they are merely browsing or “I Need Help” if they need immediate assistance from a sales associate (e.g. to locate a product). If the SP User requests assistance, they have the option of connecting with a store associate (who may be remote or on-location) through a chat session or an in-person interaction.
   1.e.iii. Offers: An SP User can preferably receive dynamic offers based on their preferences and their stated shopping intent.
   1.e.iv. Recommendations: SP Users also preferably receive customized product recommendations based on their preferences and their stated shopping intent.
   1.e.v. Event: In some sample embodiments, SP Users can enter special events designed to appeal to them based on their preferences and shopping intent.
   1.e.vi. Purchase: In some sample embodiments, SP Users can purchase a product and use a stored payment method and shipping address to complete the purchase and have the item sent to the address.
   1.e.vii. SP User Apps preferably also allow SP Users to rate Associates as well as the quality of their in-location, on-website, or in-app experience.
1.f. Messages: Used to send and store messages to and from SP-Enabled locations and other SP Users.
1.g. SP Point System: In some sample embodiments, SP Users can earn points for using the SP User App and visiting SP-Enabled merchants. These points can be used to purchase items or receive discounts.
1.H. SP Global Login: In some sample embodiments, an SP User App can be used to login to merchant websites and apps. By doing so, the merchant preferably then has access to those preferences the SP User has chosen to share with the merchant.

2. SP Hub: An SP Hub is a cloud-based component of present SP Platform implementations that stores user preferences and coordinates the communication between consumer (through the SP User App) and merchant (through the SP Store App). It preferably includes some or all of at least the following functionality:
2.a. Recognition: A recognition module identifies SP Users when they approach or enter a merchant's physical location, website or mobile app. In physical locations, the recognition process is preferably accomplished through geofencing, facial recognition, and/or other image- or video-based recognition and identification technologies that detect SP Users when they are near a location or enter a location. Promotions can be sent to an SP User who is either near the location or within the location. Sales Associates can be notified to greet a SP User by name. Any data that is specific to an SP User is most preferably wiped from a Sales Associate's device once the SP User exits the location.
2.b. Promotions: A merchant tool preferably contains e.g. details on promotional offers, business rules for when and to whom SP-specific promotions are offered, and tools for analyzing the effectiveness of promotions.
2.c. Transaction Store: In some sample embodiments, a merchant can store on-line and off-line user transactions for analysis and to build SP User preference models.
2.d. Event Organizer: In some sample embodiments, a merchant tool can be used to configure store events that appeal to SP User preferences.
2.e. Recommendation Engine: In some sample embodiments, a merchant tool recommends courses of action and suggests products and services. These recommendations can be made directly to an SP User or for a Sales Associate to offer an in-store SP User during their service interaction. Recommendations can preferably be contextualized with titles like “Because You Like the Dallas Cowboys” when recommending a shirt with a Cowboys star on the front.

3. SP Store App: Various sample implementations of an SP store app provide a set of tools for merchants, accessed through a mobile app, notifies service personnel (Associates and Managers) when an SP User is detected and provides staff with multiple courses of action (workflows) to engage the identified SP User.
3.a. Basic functionality communicates an SP User's presence, identifies the SP User (including the SP User's name and picture), and displays basic preference information (where explicitly allowed by the SP User) and recommendations/tips to service personnel based on available transaction history. This allows the service personnel to address the SP User by name, take actions to accommodate their known preferences, and/or use recommendations to cross-sell or upsell the SP User as appropriate. SP User pictures and customer details most preferably cannot be stored or copied onto the devices of the sales staff or the company after an SP User leaves the store. This personal information is most preferably removed from the store's system once the SP User leaves the location.
3.b. Tasking: SP Store tools can allow a Manager to schedule and instruct specific sales staff to meet a specific SP User. These tools preferably send a picture of the SP User to the Associate. The systems can be configured to assign a single Associate to multiple SP Users who are inside the location or dedicate staff to individual SP Users if preferred.
3.c. Advanced capabilities can, in some sample embodiments, include functionality to some or all of:
   3.c.i. Recommend and deliver promotional offers;
   3.c.ii. Create a special check-out lane where the SP User's purchase is finalized, e.g. by way of a tablet app, without the SP User having to wait in line;
   3.c.iii. Allow the SP User to schedule a personal shopper appointment with in-store staff;
   3.c.iv. Enable the SP User to communicate directly with on-site staff while the user is not on-site;
   3.c.v. Enable the SP User to notify a location that he/she is only browsing and does not want personalized service during their visit; and/or
   3.c.vi. Enable the SP User to request ad-hoc help via notification.
   3.d. Presently-preferred sample embodiments preferably allow Associates to rate an SP User based on defined parameters and to store notes in verbal or written form.
   3.e. The SP Platform can allow a SP User to rate Associates as well as the quality of their in-store experience.
   3.f. Some sample embodiments include analytic tools including, e.g., executive reporting for tracking Key Performance Indicators related to SP Users, performance of promotions, etc.
   3.g. Some sample embodiments include tools to manage all aspects of the SP Platform, including some or all of:
   3.g.i. Personnel Setup: Establish accounts for merchant Associates and Managers and establishes security settings that restrict access to role-specific portions of the platform.
   3.g.ii. Location management: Add, delete, and update location information, including geofence coordinates, Associate/Manager directories, etc.

### What Does an SP-Enabled Store Do?

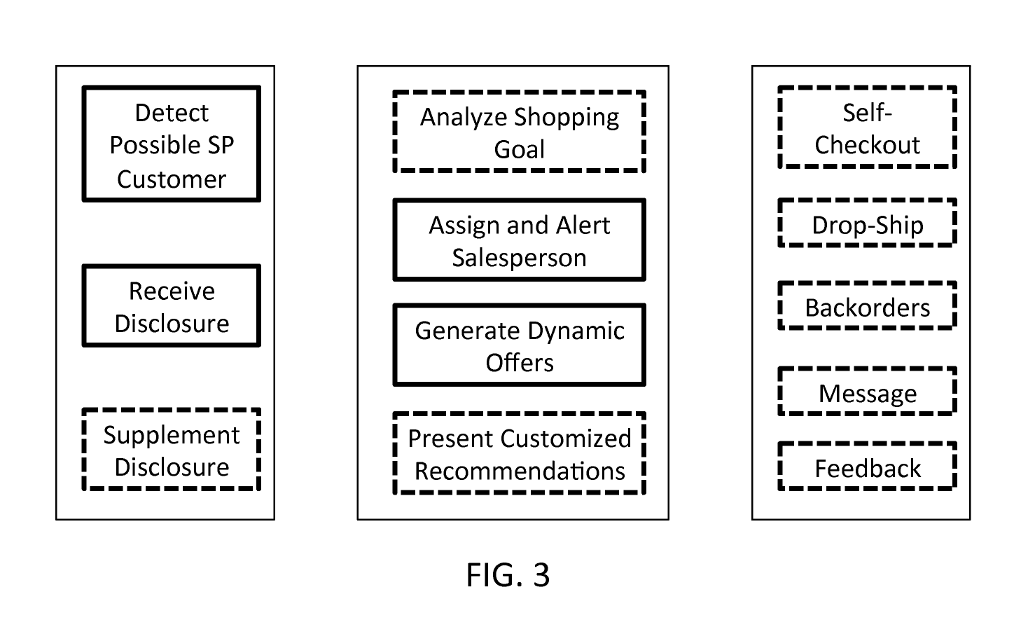

The above description shows the overall architecture of the preferred implementation. Now the operations performed by the store's electronics, some of which can be seen in the sample embodiment of FIG. 3, will be reviewed.

1) Recognition: The store system recognizes an SP user when he/she enters a location.
Note: the location-bound operations described here can also be used (and preferably are used) to provide omni-channel personalized service. However, the in-store hyperpersonalization is perhaps the most surprising service, and the extension of the in-store personalization to web-access is merely a nearly-painless extension of this capability. If secure handshaking is used to enable disclosure of personal information, the web access can optionally be given the same (or a related) handshake for security. This can be used to avoid phishing-like attacks on stored personal information.

2) Disclosure of user identity and preferences: If the store is fully SP-enabled, it is allowed to receive preference information to the extent allowed by that user's security preferences and exceptions. For example, a user might choose to disclose her shoe size, but not her bra size, to stores which are authenticated (by their SP credentials) as shoe stores; she might choose to disclose all size information to certain department stores, but none to others; she might choose to allow requests for personalization from stores authenticated as “high-end” (however that is defined), but not from jewelry stores; etc. etc. Note that a customer can choose to share nothing with unknown stores, and preferably can choose not even to allow requests for information from unknown SP-enabled stores.

If disclosure of user preferences is allowed, it may be allowed only for duration of the visit. The store's SP system can be used as a security gate to avoid leakage of user preference data. Preferably, the customer can also choose to put different security constraints on sharing preference socially with other users.

The store's system can then preferably qualify shopping intent by, for example, whom the SP User is shopping for, the occasion, desired item type, and price range, if disclosed, and can recommend products/services based on a user's preferences and available inventory.

The store can also build DYNAMIC promotions based on a particular user's (or users') preferences. This can be used to conduct engaging in-store promotional events. Since a dynamic promotion is formulated in real-time, it can be very short-lived (e.g. minutes or a few hours). Since a dynamic promotion can be very precisely tailored to a user's profile, it can be priced optimally, i.e. at a price point which gives good profitability while building customer loyalty.

The information disclosed to the SP store can also be used to enable self-service checkout, order out-of-stock items, ship to a preferred address, or pay with stored payment methods.

The SP User can also be asked to provide instant (or delayed) feedback on interactions with the store and its staff

Customer-loyalty programs can also be used to incentivize participation in the SP disclosure process by qualified users.

Hardware Installation

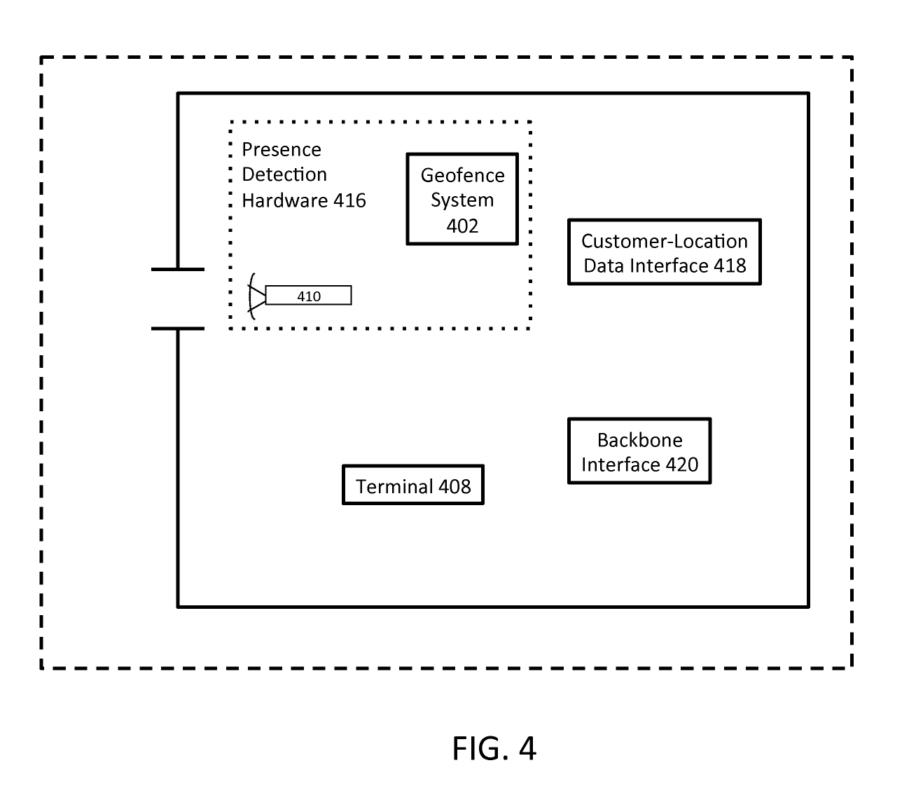

In order to perform the above operations, the store (or physical location) should preferably have, as seen in the sample embodiment of FIG. 4: proximity detection hardware 416, such as geofencing platform 402; a camera 410 which can see the faces of incoming customers; a two-way data interface 418 to an SP customer's mobile device; a data interface 420 to a data and authentication “backbone” system; and local or remote computing capability, such as terminal 408. The store preferably also has some software controls as described below.

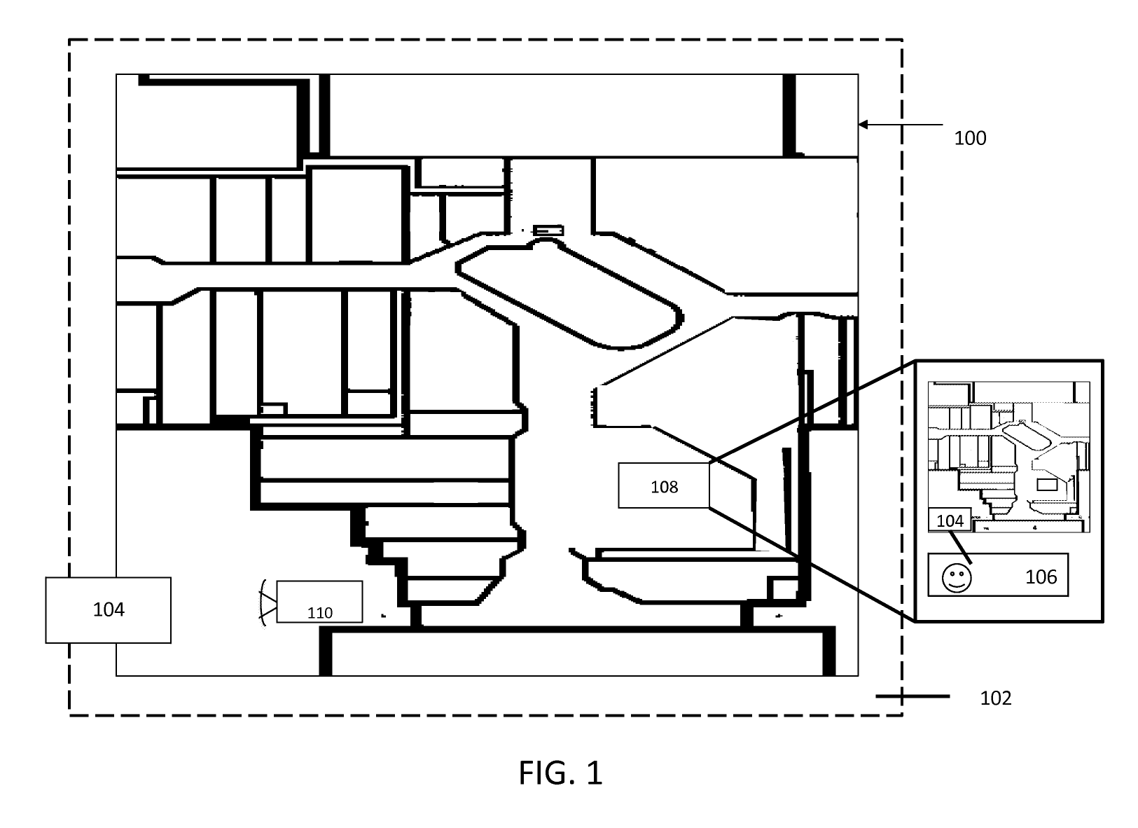

In the sample embodiment of FIG. 1, geofence system 102 is established at location 100. When mobile unit 104 comes into range of geofence system 102 and enters location 100, customer data 106 is transmitted to merchant terminal 108. In some sample embodiments, camera 110 takes a picture when mobile unit 104 enters location 100 and sends this picture to terminal 108 with customer data 106.

In one sample embodiment, customer data 106 is intermittently updated to track the position of mobile unit 104 within location 100.

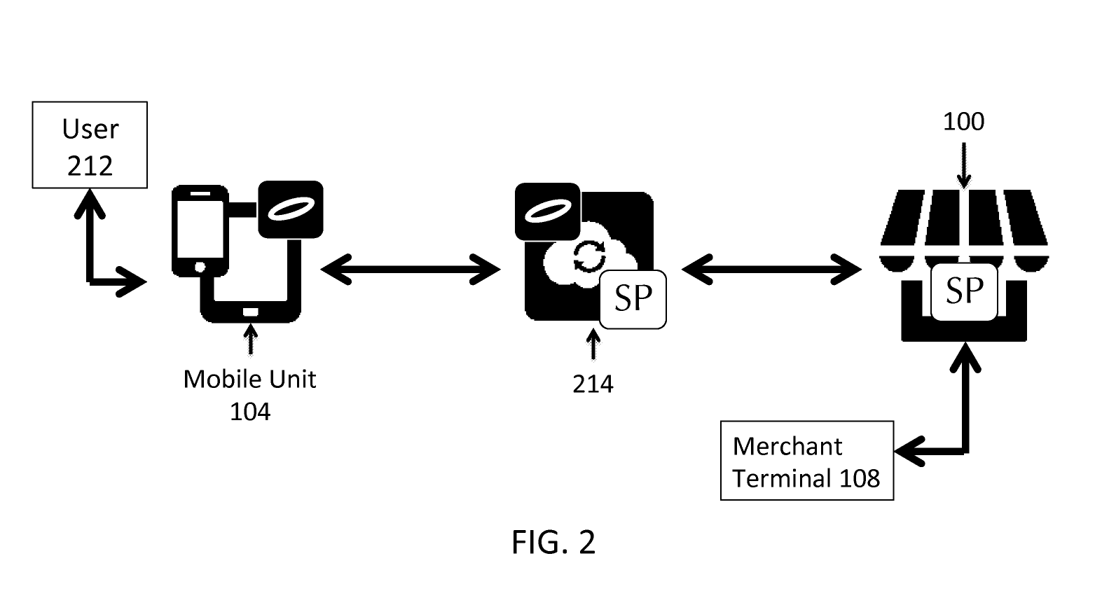

The sample embodiment of FIG. 2 shows a schematic overview of how information is shared between user 212, mobile device 104, SP service 214, location 100, and merchant terminal 108. Access by the merchant at location 100 to information about user 212 is most preferably limited to terminal or terminals 108. In some sample embodiments, SP service 214 removes information about user 212 from terminal 108 once user 212 leaves location 100.

### The “Back-Office” Behind SP Sharing

The requirement for authentication and data control requires some server or infrastructure which can restrict access to customers' private data. This can be very simple (e.g. a mere authentication server), or can include the full SP Hub functionality described above, or can be combined with other functions.

### The SP Store's Client

The “SP Store App” described above is just one way to implement the merchant-side operations. Some of the biggest advantages for an SP Store come from access to remote data, especially to customer preferences developed elsewhere. A customer's buying habits within a chain of stores, for example, can provide very useful information, especially in combination with the customer's disclosure of preferences. This information can be valuable proprietary data, and, like the customer's private information, should be protected. One way to do that is with a software component which preserves some security controls over the sensitive data.

Once the customer's preferences are accessible, analysis can be run to generate customized recognition and staff assignments, as described above. This analysis can be run locally, by computing hardware at the location, or remotely.

Note particularly that presently-preferred embodiments of SP systems have the capability to assign a sales associate to a visiting customer based on a configurable engine that takes into account the user's preferences and shopping intent to assign the best associate for that user. This can be implemented remotely by the SP Hub subsystem, or can be implemented locally. The sales associate may physically be in store, or may be remote and communicate with the user by a chat function. Depending on the store's configuration, remote or local interaction can be dispatched selectively, e.g. prioritizing a personal approach for high-dollar customers.

### The Mobile App

The “SP User App” described above is not the only possible implementation; the user's mobile app can be very simple, and even the simplest part of the system. It should preferably:
build a map of the user's preferences;
follow the user's settings on when and whether to disclose such preferences as a user chooses to enter;
automatically disclose information, subject to the user's defined controls, when a ping is received from an authenticated SP store;
(optionally) allow an SP Store to make a request for access to user preferences;
(optionally) allow an SP Store to request the user to specify additional preferences, such as shoe size, which may be relevant to that store;

and perform additional interface and communication functions, as in many other smart-phone apps, for interface to the merchant.

### Sample User Stories for the Services Personalized Platform:

Sample User Story for Large Chain Restaurant with Deep Own-App Penetration.

Peter Chapman is a loyal customer of “Sbx,” a hypothetical business similar to Starbucks™. (NOTE: no representation is implied that any Starbucks™ entity uses or endorses the technology described herein: the following should be considered as a hypothetical application study in a familiar business context.) Peter is a savvy technology user and has used a smart phone for years. Peter also loves his loyalty benefits wherein he gets the 13th coffee free of cost if he uses the electronic wallet within the Sbx app.

Since Peter also travels extensively he has kept the location service enabled on his smart phone. He has also allowed the Sbx app to find his current location, thus enabling him to find the nearest Sbx location wherever he is. He also has connected a picture from a social media account with his Sbx account.

Sbx now wants to work with the Services Personalized platform to provide a hyperpersonalized experience to all users like Peter Chapman. Services Personalized immediately enables all Sbx stores with geofencing. There is a plugin that is inserted into the Sbx application made available by Services Personalized and releases a new enhancement to all Sbx app users. Peter upgrades his application and the new plugin is installed.

Next morning, Peter walks into a Sbx he has never before visited, passing the geofence that was created by Services Personalized. As he enters at that time or stands in the queue and approaches the register to place his order, Betty, a Sbx employee, sees the picture of Peter Chapman in an alerts window on her point-of-sale system (“POS”) or any store mobile device (tablet, smartphone) along with his name and previous orders he had placed. As he approaches her, she greets him by name and asks him if he would like his usual order.

What happened behind the scenes from a data flow standpoint:

1. The deal is signed between Services Personalized and Sbx. Through the setup process all Sbx locations are geofenced and each location is assigned an internal identifier.

2. As soon as Peter walked into the Sbx, the Sbx application raised an event stating that a geofence was communicated back to the Services Personalized server, including the store location identifier associated with the geofence.

3. The Services Personalized service took the data and pushed it through to a generic interface that it uses to communicate with its customer.

4. The interface published the above data to the Sbx store's POS terminal.

5. The POS has an alerts screen where Peter's name and picture from the SP platform, and order history from Sbx's sales history, are displayed as relayed by Services Personalized.

Sample User Story for Restaurants with No Apps and/or Large User Base:

Jeff Gladden is a businessman who enjoys good food and personalized service. He normally goes to a few of his favorite restaurants in his hometown where he knows the owner.

Jeff would like to explore new restaurants and get personalized service when he is on business travel. He sees an ad about an app that recognizes you by name at thousands of restaurants.

He downloads the app and signs up with a social media account or enters his food preferences using the SP User app. The app pulls in his picture from the social media account, if Jeff prefers, or he takes his own picture with his phone camera. Also, if authorized by Jeff, preferences can be pulled from his social media account based on his discussions with friends.

He walks into “Martin's” in Chicago and the receptionist sees his picture and profile immediately on her tablet at the reception desk. (“Martin's” is a hypothetical high-end steakhouse, similar to Morton's Steakhouse.™ However, this example should be considered as a hypothetical study of a possible application, and no representation is made that Morton's Steakhouse,™ nor any associated individual or entity, has adopted or endorsed the technology described in this application, nor any relation with the applicant nor its principals.)

The receptionist greets Jeff by name and welcomes him. She can also push him to the top of the queue for getting a premium table, based on his history.

The waiter at the table gets an alert on his personal cell phone with Jeff's name, his favorite drink, his favorite cut of steak and how he likes it prepared. He greets Jeff by name and asks if he would like his favorite martini. Jeff is surprised and pleased that they are providing him with same level of service that he is used to at his favorite steakhouse at home.

What happened behind the scenes from a data flow and app standpoint:

1. When Jeff downloaded the app and agreed to let it use location services, as well as sign in with his social media account, the app downloaded his social media profile and picture. It then parsed through his social media posts to find any other preferences it could register. Jeff could have also chosen to enter data using the SP User app rather than integrating with social media.

2. Jeff's profile was stored in the SP Hub database.

3. Martin's Steakhouse was one of the restaurants that was participating in the SP service.

4. Martins' locations were automatically geofenced using a location database when Martin's agreed to participate.

5. Martin's downloaded the app on a tablet at reception desk at all locations and signed on as a SP service provider.

6. When Jeff entered the Martin's geofence, the app recognized the geofence and sent a location message to the SP Hub.

7. The SP Hub searched its service provider database to find the reception tablet account and pushed Jeff's profile to the SP app on the tablet.

8. When the receptionist assigned a table to Jeff, she pressed Customer Seated on Jeff's profile notification.

9. This triggered SP to send a profile update text to the waiter who was going to wait on Jeff

10. The waiter received key profile info from the SP app to greet the customer by name and offer him his favorite drink and menu item.

11. When Jeff left Martin's, the SP app recognized that he had left the restaurant. It calculated the amount of time the phone was in the restaurant and determined that Jeff had been there for dinner

12. The SP app sent a thank you note from Martin's to Jeff, signed by the receptionist by name.

### Sample User Story for Retail Department Store:

Mary likes to shop at the “Z” store, as well as at Macy's, Neiman Marcus, Burberry, and JC Penney. (“Z”, like “Martin's” and “Sbx” above, is a hypothetical business entity assumed to be similar to these four chain stores.)

Mary gets email offers from Z because she signed up for their credit card.

She gets an email offer from Z inviting her to download the SP User app for personalized service.

Mary downloads the app and agrees to let the app set up her account either from her social media page or by manually entering data using the SP User app. She also agreed to let the app use her location information.

Mary goes to Z the next day, and as she walks into the store an Associate walks up to her and greets her by name. Mary is surprised and pleased to be noticed.

The Associate has received a notification of Mary's profile and some preferences. She asks Mary what she is in the mood to buy today and based on Mary's response, she pulls her preferences (from the SP Hub) for that particular category (such as formal clothing, business attire, casual, exercise, shoes, cosmetics, purses, jewelry, etc.), guides Mary to the specific department and helps Mary shop based on her preferences. The SP Platform may also send recommendations/tips to the Associate by integrating Mary's preferences with her purchase history.

As Mary looks at clothes, the Associate helps her with questions based on Mary's profile that she saw on her phone. Mary is pleased to have someone with taste just like her and decides to buy three outfits. The Associate can also upsell to Mary based on SP Hub-provided recommendations/tips.

As Mary leaves Z she gets a thank you note on her phone signed by the Associate.

What happened behind the scenes from a data flow and app standpoint:

1. Z was one of the department stores that were participating in the SP service.

2. Z locations were geofenced using a location database (automatically setup when Z agreed to participate).

3. Z sent all its loyalty program customers an email announcing the SP service with a link to download the app.

4. Z asked all its associates to download the SP app on their personal phone and enter their employee number to register as an Associate.

5. The Associate's data was stored in the SP Cloud.

6. When Mary downloaded the app and agreed to let it use location services, as well as sign in with her social media account, the app downloaded her social media profile and picture. It then parsed through her social media posts to find any other preferences it could register. Mary could also decide to manually enter data in the SP User app and not integrate with social media.

7. Mary's profile was stored in the SP Cloud database.

8. When Mary triggered Z′s geofence, an alert was sent to the SP Cloud, which relayed it to the appropriate individual at the Z location, along with the relevant details on Mary's preferences.

9. The Z Associate, having signed into the SP app on her phone, was notified of Mary's arrival and given her preferences.

10. The SP app also listed recommendations for Mary, based on Mary's preferences, purchase history and current shopping interests.

11. Once Mary selected her items, the SP app is used to send her a follow-up note thanking her for her visit, asking her to rate her experience and make suggestions for Z to improve their in-store experience.

12. Mary responds and Z uses this data to track their progress against defined objectives.

Comparison with Other Approaches

It is important to note that one key element of the SP architecture is voluntary disclosure by the consumer. This point alone distinguishes the SP architecture from almost all other proposed techniques for hyperpersonalization. However, the synergy of voluntary disclosure with localized interaction provides important further advantages, since security is improved significantly.

A number of other approaches and solutions exist, but conventional solutions omit the voluntary disclosure elements of the present innovations. Users typically have little or no control over what data is available about them. Marketers and merchants, on the other hand, usually prefer to collect as much data as they can about users, and tend to make it difficult or impossible for users to withhold any type of data.

Extension to Omni-Channel Selling

The systems and architecture described above provide a new approach to localized selling. However, omni-channel capabilities can easily be added onto this localized selling approach. For example, a consumer would preferably be allowed to disclose selected portions, from the same set of information, to the internet site of an authorized SP seller. Once the basic SP interaction has been defined, this extension is simple to implement; however, internet interactions do not have the personal interaction of in-store sales, and are not as secure as in-store sales.

The SP store's system can also provide the interface for in-store hyperpersonalized shopping for items which are not in stock, so that a customer can select models which are not in stock.

Extension to Remote Customer Service

The systems and architecture described above provide a new approach to localized selling by salespersons in the same location. However, the SP store's system can also be used to connect a user to a remote help desk, in addition to or instead of summoning a face-to-face salesperson.

Extension to Transaction-Related Sharing

The customer preferences listed above can be categorized generally as shopping-related sharing (e.g. budget, today's shopping intent, sizes). Shopping-related sharing is quite different from transaction-related sharing where purchase-related information, such as shipping address and payment information, can be shared. Transaction-related sharing is simpler, and use far less sensitive personal data.

With that distinction understood, it can be seen that controlled disclosure of shopping-related sharing is really a separate operation from sharing of transaction-related information. The two do not necessarily go together: for example, a shopper might be comfortable with shopping-related sharing as described, but still be reluctant to share banking or debit-card information.

Extension to External Data

The systems and architecture described above provide a new approach to localized selling, using voluntarily disclosed data. However, this unique approach can also be combined with data acquired from public sources or data aggregators. This combination provides a powerful extension to the basic interactions described above.

Extension to Analytics

Data analysis tools (“analytics”) are becoming continually more sophisticated, and it is foreseeable that analytics will soon be able to discern, as a human would, what recognizable brands a shopper is wearing, what degree of affluence her attire and accessories show, and what her style may show about mood and approach on that particular day. The systems and architecture described above provide a new approach to localized selling, using voluntarily disclosed data. However, this unique approach can also be combined with analytics, to provide a powerful extension to the basic interactions described above. For example, when a shopper appears to be open to cutting-edge styles, this can be used to fine-tune recommendations based on the shopper's basic disclosure.

Extension to Social Networking

The systems and architecture described above can also be extended to social networking capabilities. For example, shoppers might choose to allow identified friends to see some or all of the size data in their personal preferences. This makes gift shopping for an SP customer easier, and provides a “viral marketing” route to expand the base of SP customers. Shoppers may also chat, while shopping, about their shopping. This capability too is an easy addition to the basic architecture and operations described above.

Data Security

The localized nature of the in-store disclosure adds an important level of security to the customer's disclosure of information. A perennial problem, when sensitive private information is electronically accessed, is leakage. It is important to note that the localized nature of in-store interactions, according to the SP architecture, adds an additional layer of security to the disclosure of personal information. No security is perfect, but the localization element adds to the customer's security in allowing disclosure.

Additional security features can be added into the SP architecture if desired. For example, the store's SP application can be configured as a middleware object which runs selected algorithms on the customer's data, but does not release the customer's raw data except under specified conditions. For another example, various authentication and handshaking routines can be used to verify that a purported SP store is in fact in approximately the same physical location as the customer, and is in fact an authorized SP store.

Industry: Financial Services

Note that the SP architecture provides particular advantages for banks, stockbrokers, insurance brokers, and other financial industries. Here it is advantageous to offer high-end greeting and accommodation to real customers and qualified potential customers, without wasting resources on persons who do not fit either category. The SP architecture is particularly advantageous here, since high-net-worth individuals may expect a high level of service, yet also be skittish about being identified publicly.

A particular advantage in these industries is that welcoming and hyperpersonalization techniques can be used to provide a high level of services to travelers, with the possibility of building relations. Here potential customers can be prequalified painlessly, if they choose to disclose.

Industry: Medical Services

The privacy protection provided by the SP architecture is particularly advantageous for medical service providers. Typically the SP hyperpersonalization would be combined with other security techniques, such as inspection of photo ID. However, the chance to provide better personal interaction with qualified customers (patients) can be a strong differentiator which builds loyalty to a particular practice and can reduce errors and improve service delivery. This can be particularly important in countries where some patients have private medical insurance and some do not.

Industry: Sales of Automobiles Etc.

Sales of high-end consumer goods presents a unique challenge, in that buying cycles will usually be slow enough that many buyers will not have any existing relationship with the merchant. This is particularly acute with new car sales.

One of the challenges in new car sales is qualifying buyers. The value of each transaction is large enough that niceties for qualified buyers are worth investing in if unqualified buyers can be avoided. This is a general challenge in many high-dollar consumer purchases. With the SP architecture, buyers can be invited to disclose enough information to be identified as qualified prospects, and the qualified prospects can be given “red-carpet” treatment.

Industry: Real Estate Sales

The need for qualification of buyers is especially high in residential real estate sales. Here too the SP disclosure architecture can be particularly helpful in converging rapidly on good offerings for a particular homebuyer.

Industry: Hospitality

Hotels, like restaurants, provide some degree of “home away from home” comfort. The painless hyperpersonalization which is provided by the SP disclosure architecture can be particularly advantageous here, just as in the restaurant industry.

Industry: Business-to-Business Stores

It should be noted that the benefits of consumer retail, discussed above, also apply to merchants who sell to businesses. For example, in the US, Grainger's™ or Staples™ are chain merchants who could benefit by personalized greetings to walk-in customers, appropriate tasking of sales staff, and resulting customer loyalty.

Advantages

The disclosed innovations, in various embodiments, provide one or more of at least the following advantages. However, not all of these advantages result from every one of the innovations disclosed, and this list of advantages does not limit the various claimed inventions.
Improved privacy for individuals.
Improved availability of hyperpersonalized sales interactions.
Improved customer loyalty.
Better success at cross-selling and upselling.
Better success at social-networked selling, i.e. selling to friends of an SP customer.
Maximize efficiency of available salespersons.
Faster shopping, for shoppers who have a goal.
The customer is a participant in getting the information to maximize the mutual benefit of the hyperpersonalization. This has two benefits: not only is the data provided by the customer more accurate (in many ways), but also the customer becomes a partner in the process of obtaining the data needed for hyperpersonalization. This not only protects privacy, and respects the requirements of privacy laws where those are important, but also can avoid some resistance to intrusive inquiries.

According to some but not necessarily all embodiments, there is provided: A merchant system, comprising: a presence detector which detects the presence of a customer who carries a mobile device which can perform secure shopping-related disclosure using a standardized interface; a camera positioned to see the faces of incoming potential customers; a wireless data interface which can receive shopping-related disclosure of shopping-related preferences from a customer's mobile device; a display which is viewable by at least one salesperson, and which is able to show a recognizable image of that shopper together with information about that shopper's goal, preferences, and/or buying history; and a computing system which receives disclosure of the shopper's identity and/or preferences from that shopper's mobile device through the wireless interface, and accordingly shows the image of that shopper, and information based on that shopper's preferences, to at least one salesperson using the display.

According to some but not necessarily all embodiments, there is provided: A merchant system, comprising: a presence detector which detects the presence of a customer who carries a mobile device which can perform secure shopping-related disclosure using a standardized interface; a wireless data interface which can receive shopping-related disclosure of identity and shopping-related preferences, from a customer's mobile device; a display which is viewable by at least one salesperson, and which is able to show a recognizable image of that shopper together with information about that shopper's goal, preferences, and/or buying history; and a computing system which receives disclosure of the shopper's identity and/or preferences from that shopper's mobile device through the wireless interface, and accordingly shows the image of that shopper, and information based on that shopper's preferences, to at least one salesperson using the display.

According to some but not necessarily all embodiments, there is provided: A merchant system, comprising: a geofencing subsystem which detects the presence of a shopper who carries a mobile device which can perform shopping-related sharing of identity and shopping-related preferences; a wireless data interface which can receive shopping-related disclosure of identity and shopping-related preferences, from a customer's mobile device; a display which is viewable by at least one salesperson, and which is able to show a recognizable image of that shopper, together with information about that shopper's preferences, and/or buying history; and a computer system which receives disclosure of that shopper's identity and/or preferences from that shopper's mobile device, and accordingly shows the image of that shopper, and information based on that shopper's preferences, to at least one salesperson who is at the same physical location as that shopper.

According to some but not necessarily all embodiments, there is provided: A merchant system, comprising: a presence detector which detects the presence of a shopper who carries a mobile device which can perform shopping-related disclosure; a wireless data interface which can receive shopping-related disclosure of identity and shopping-related preferences, including preference for anonymity, from a customer's mobile device; a display which is viewable by at least one salesperson, and which is able to show a recognizable image of that shopper together with information about that shopper's preferences; and a computer system which receives disclosure of the shopper's identity and/or preferences from that shopper's mobile device, and accordingly does or does not assign a salesperson to greet that shopper, based partly on the preference for anonymity disclosed in the shopper's preferences.

According to some but not necessarily all embodiments, there is provided: A merchant system, comprising: a presence detector which detects the presence of a customer who carries a mobile device which can perform secure shopping-related disclosure using a standardized interface; a wireless data interface which can receive shopping-related disclosure of identity and shopping-related preferences, and current shopping goal, from a customer's mobile device; a display which is viewable by at least one salesperson, and which is able to show a recognizable image of that shopper together with information about that shopper's goal, preferences, and/or buying history; and a computing system which receives disclosure of the shopper's identity and/or preferences from that shopper's mobile device through the wireless interface, and accordingly shows the image of that shopper, and information based on that shopper's preferences, to at least one salesperson using the display.

According to some but not necessarily all embodiments, there is provided: A method of operating a merchant system, comprising: detecting the presence of a customer who carries a mobile device that can perform secure shopping-related disclosure using a standardized interface; capturing images of the faces of incoming potential customers; receiving shopping-related disclosure of shopping-related preferences from a customer's mobile device; receiving disclosure of said customer's identity and/or preferences from that customer's mobile device through the wireless interface; and sending a recognizable image of said customer together with information about that shopper's goal, preferences, and/or buying history to a display which is viewable by at least one salesperson.

According to some but not necessarily all embodiments, there is provided: A method of operating a merchant system, comprising: detecting the presence of a customer who carries a mobile device that can perform secure shopping-related disclosure using a standardized interface; receiving shopping-related disclosure of shopping-related preferences from a customer's mobile device; receiving disclosure of said customer's identity and/or preferences from that customer's mobile device, by way of a wireless interface; and sending a recognizable image of said customer together with information about that shopper's goal, preferences, and/or buying history to a display which is viewable by at least one salesperson.

According to some but not necessarily all embodiments, there is provided: A method of operating a merchant system, comprising: detecting the presence of a shopper who carries a mobile device that can perform shopping-related sharing of identity and shopping-related preferences using a geofencing subsystem; receiving shopping-related disclosure of identity and shopping-related preferences, by way of a wireless data interface, from a customer's mobile device; and displaying an image of that shopper, and information based on that shopper's preferences, to at least one salesperson who is at the same physical location as that shopper.

According to some but not necessarily all embodiments, there is provided: A method of operating a merchant system, comprising: using a presence detector to detect the presence of a shopper who carries a mobile device which can perform shopping-related disclosure; using a wireless data interface to receive shopping-related disclosure of identity and shopping-related preferences, including preference for anonymity, from a customer's mobile device; using a computer system to receive disclosure of the shopper's identity and/or preferences from that shopper's mobile device, and accordingly does or does not assign a salesperson to greet that shopper, based partly on the preference for anonymity disclosed in the shopper's preferences; and if a salesperson is assigned to greet that shopper, displaying a recognizable image of that shopper together with information about that shopper's preferences to the assigned salesperson.

According to some but not necessarily all embodiments, there is provided: A method of operating a merchant system, comprising: detecting the presence of a customer who carries a mobile device which can perform secure shopping-related disclosure using a standardized interface, using a presence detector; receiving shopping-related disclosure of identity and shopping-related preferences, and current shopping goal, from a customer's mobile device, using a wireless data interface; receiving disclosure of the shopper's identity, preferences, and/or current shopping goal from that shopper's mobile device through the wireless interface; and showing the image of that shopper, and information based on that shopper's preferences and current shopping goal, to at least one salesperson using a display.

According to some but not necessarily all embodiments, there is provided: A method of operating a merchant system, comprising: detecting the presence of a customer who carries a mobile device that can perform secure shopping-related disclosure using a standardized interface; receiving shopping-related disclosure of shopping-related preferences from the customer's mobile device; receiving disclosure of said customer's identity and/or preferences from that customer's mobile device, by way of a wireless interface; sending a recognizable image of said customer together with information about that customer's goal, preferences, and/or buying history to a display which is viewable by at least one salesperson; generating one or more dynamic offers based on the customer's goal, preferences, and/or buying history; and sending the one or more dynamic offers to the customer's mobile device, using the wireless interface.

Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

A very large number of modifications have already been indicated above. In addition to these, following are some other variations.

The systems described are not limited to merchants strictly speaking, and are certainly not limited to sale of tangible goods. For example, banks, restaurants, hospitals, doctors' offices, law firms, religious or charitable organizations, or government offices can all use the disclosed innovations in various ways.

For another example, the capability to identify the best fit for shoppers will also produce, as a secondary benefit, identification of potential threats (such as thieves or robbers). The more saturation is achieved with SP shoppers, the more attention can be paid to non-SP persons who enter the store.

Many of the particular industry applications indicated above will need particular kinds of preference data. For example, a religious organization might like to be alerted that a visitor is unaffiliated and/or seeking.

In some sample embodiments described above, customer recognition and identification is implemented inter alia by geofencing and/or by facial recognition or other image- or video-based identification. However, other implementations are also considered within the scope of the present inventions, such as an RFID-enabled SP loyalty card.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A merchant system, comprising:
a presence detector which detects the presence of a customer who carries a mobile device which can perform secure shopping-related disclosure using a standardized interface;
a camera positioned to see the faces of incoming potential customers;
a wireless data interface which can receive shopping-related disclosure of shopping-related preferences from a customer's mobile device;
a display which is viewable by at least one salesperson, and which is able to show a recognizable image of that shopper together with information about that shopper's goal, preferences, and/or buying history; and
a computing system which receives disclosure of the shopper's identity and/or preferences from that shopper's mobile device through the wireless interface, and accordingly shows the image of that shopper, and information based on that shopper's preferences, to at least one salesperson using the display.

2. A merchant system, comprising:
a presence detector which detects the presence of a customer who carries a mobile device which can perform secure shopping-related disclosure using a standardized interface;
a wireless data interface which can receive shopping-related disclosure of identity and shopping-related preferences, from a customer's mobile device;
a display which is viewable by at least one salesperson, and which is able to show a recognizable image of that shopper together with information about that shopper's goal, preferences, and/or buying history; and
a computing system which receives disclosure of the shopper's identity and/or preferences from that shopper's mobile device through the wireless interface, and accordingly shows the image of that shopper, and information based on that shopper's preferences, to at least one salesperson using the display.

3. A merchant system, comprising:
a geofencing subsystem which detects the presence of a shopper who carries a mobile device which can perform shopping-related sharing of identity and shopping-related preferences;
a wireless data interface which can receive shopping-related disclosure of identity and shopping-related preferences, from a customer's mobile device;
a display which is viewable by at least one salesperson, and which is able to show a recognizable image of that shopper, together with information about that shopper's preferences, and/or buying history; and
a computer system which receives disclosure of that shopper's identity and/or preferences from that shopper's mobile device, and accordingly shows the image of that shopper, and information based on that shopper's preferences, to at least one salesperson who is at the same physical location as that shopper.

4-5. (canceled)

6. The system of claim 1, wherein the presence detector is a geofencing subsystem.

7. The system of claim 1, wherein the display is provided by the salesperson's mobile device.

8-13. (canceled)

14. A mobile device programmed and operated in accordance with claim 1.

15. The system of claim 2, wherein the presence detector is a geofencing subsystem.

16. The system of claim 2, wherein the display is provided by the salesperson's mobile device.

17. A mobile device programmed and operated in accordance with claim 2.

18. The system of claim 3, wherein the display is provided by the salesperson's mobile device.

19. A mobile device programmed and operated in accordance with claim 3.
